(19) United States
(12) Patent Application Publication
(10) Pub. No.: US 2012/0256845 A1
(43) Pub. Date: Oct. 11, 2012

(54) VERIFYING INPUT TO A TOUCH-SENSITIVE DISPLAY SCREEN ACCORDING TO TIMING OF MULTIPLE SIGNALS

(75) Inventor: Robert T. Noble, Raleigh, NC (US)

(73) Assignee: INTERNATIONAL BUSINESS MACHINES CORPORATION, Armonk, NY (US)

(21) Appl. No.: 13/079,868

(22) Filed: Apr. 5, 2011

(51) Int. Cl. G06F 3/041

(52) U.S. Cl. 345/173

(57) ABSTRACT

A system and method are disclosed for detecting and interpreting touch input to a touch-sensitive display screen, while identifying and excluding activity not intended as touch input. A positional sensor is used to obtain positional information of a touch to the display screen using a finger or stylus. Intended touch input is verified by sensing vibration, displacement, or other movement caused by an impulse to the display screen to verify that the activity is intended as touch input. Intended touch input is further verified by timing signals from the positional sensor and the impulse sensor to determine that these two signals likely resulted from intended touch input, and not from separate or unrelated activity not intended as touch input.

### BACKGROUND

1. Field of the Invention

The present invention relates to electronic input and output devices, and more particularly to touch-sensitive display screens.

2. Background of the Related Art

A touch-sensitive display screen, alternately referred to as a touchscreen, is an interactive visual display that functions as both an input device and an output device. A touchscreen combines the visual output of a display screen with electronic circuitry that allows for electronic input by touching a display area of the touchscreen. Touchscreens are commonly incorporated into general purpose computers, computer terminals, electronic and computerized appliances, computerized kiosks, personal digital assistants (PDAs), smart phones, digital cameras, and other portable electronic devices. For example, a touchscreen is commonly provided at a point-of-sale (POS) environment, such as a grocery store or retail checkout, for assisting with input and management of items for purchase.

A number of different types of touchscreen technologies are known in the art. A resistive touchscreen uses inner and outer layers coated with a transparent metal oxide coating, whereby touching the touchscreen causes electrical contact between the inner and outer layers to complete a circuit. An infrared (IR) touchscreen uses an array of X-Y infrared LED beams that intersect at different locations to identify where the touchscreen is touched. A surface acoustic wave (SAW) touchscreen uses ultrasonic waves that pass over a panel, such that a portion of the wave is absorbed when the panel is touched. A capacitive touchscreen includes an insulator, such as glass, coated with a transparent conductor, wherein touching the surface of the panel with a bare finger causes a localized change in capacitance. Surface capacitive technology is one example of a capacitive touchscreen technology wherein a small voltage is applied to one side of the insulator, such that contact with a user's finger forms a dynamically-formed capacitor. Projected capacitive technology is another example of a capacitive technology wherein an X-Y grid pattern of electrodes is formed by etching into the conductive layer.

### BRIEF SUMMARY

Systems and methods are disclosed providing two levels of verification for confirming intended touch input to a touch-sensitive display screen. In one example of a method disclosed below, an impulse to a display screen is detected using an impulse sensor. A touch to a touch-sensitive area of the display screen is also detected using a separate sensor. A sensor status is held for a predefined waiting period following the first of the detected impulse and the detected touch. A time window is initiated at the end of the predefined waiting period. Verifying intended touch input then includes checking for the other of the impulse and the touch to occur during the time window. An intended touch input is confirmed in response to the other of the impulse and the touch having occurred during the time window.

An example of a touch-sensitive input/output device is also disclosed. The device includes a display screen, an impulse sensor, a positional sensor, and a controller. The impulse sensor is coupled to the display screen, and is configured for detecting an impulse to the display screen and generating an impulse signal in response. The positional sensor is configured for detecting a position of touch to the display screen and generating a positional signal in response. The controller includes control logic for holding a sensor status for a predefined waiting period following the first of the detected impulse and the detected touch. The controller initiates a time window at the end of the predefined waiting period, and checks for the other of the impulse and the touch to occur during the time window. The controller confirms an intended touch input in response to the other of the impulse and the touch having occurred during the time window.

### BRIEF DESCRIPTION OF THE SEVERAL VIEWS OF THE DRAWINGS

FIG. 1 is a schematic diagram of an example of a touch-sensitive input/output device providing two levels of verification for confirming intended touch input.

FIG. 2 is a schematic diagram of an IR sensor array, provided as an example of touch-sensitive circuitry that may be used with the display screen of FIG. 1.

FIG. 3 is a flowchart of an example method of detecting and interpreting touch input to a touch-sensitive display screen, while identifying and excluding activity not intended as touch input.

FIG. 4 is a timing diagram illustrating the verification of intended touch input as confirmed by coinciding impulse and positional information.

FIG. 5 is a timing diagram illustrating the timing of signals arising from unassociated events distinguishable from intended touch input.

### DETAILED DESCRIPTION

A system and method are disclosed for processing touch input to a touch-sensitive display screen, while more effectively excluding activity not intended as touch input. In an example system, a touch sensitive display screen incorporates both a positional sensor and an impulse sensor. The positional sensor registers the position at which the display screen is touched. The impulse sensor registers an impulse caused by detectable movement of the display screen, such as an impact to the display screen, consistent with touch input by a finger or stylus. Both sensors have normal delays inherent to processing detected activity before registering the respective impulse or positional information; the detected activity is therefore registered at some brief time after the activity actually occurred. Activity is verified as intended touch input by analyzing the signals from the positional sensor and the impulse sensor, as governed by control logic included with a primary controller. If the signals from the sensors are consistent with a display area being touched by a user's finger or a stylus, the positional information registered by the position sensor is then interpreted as touch input.

A first level of verification (concurrence) is provided by requiring the activity detected by the positional sensor and impulse sensor to have been registered before confirming touch input. Activity that triggers the positional sensor without triggering the impulse sensor, such as dust settling on the display screen or an object (e.g. the palm of a user's hand) hovering near the display screen, may be ruled out as being extraneous activity. Thus, any positional information registered by the position sensor is ignored in that instance if an impulse is not concurrently registered.

A second level of verification (coincidence) is provided to more effectively exclude activity not intended as touch input. Coincidence is established by analyzing the timing by which the impulse and positional information are registered by the respective sensors, to confirm that the signals from the two sensors arose from the same activity. For example, dust settling on the screen may trigger the positional sensor, without registering an impulse. A subsequent card swipe or bump to a display bezel may register an impulse, without registering positional information. A shortened time window is initiated at the conclusion of a predefined waiting period following the first of the detected impulse and the detected positional information. The timing window is selected to span a range of time that the other of the two sensors is expected to register the respective activity assuming both sensors are triggered by the same event. The time window is based, in part, on the inherent sensor delays in registering the respective signals. If the other of the two signals is not detected within that time window, the two signals are concluded to have been caused by unassociated activities.

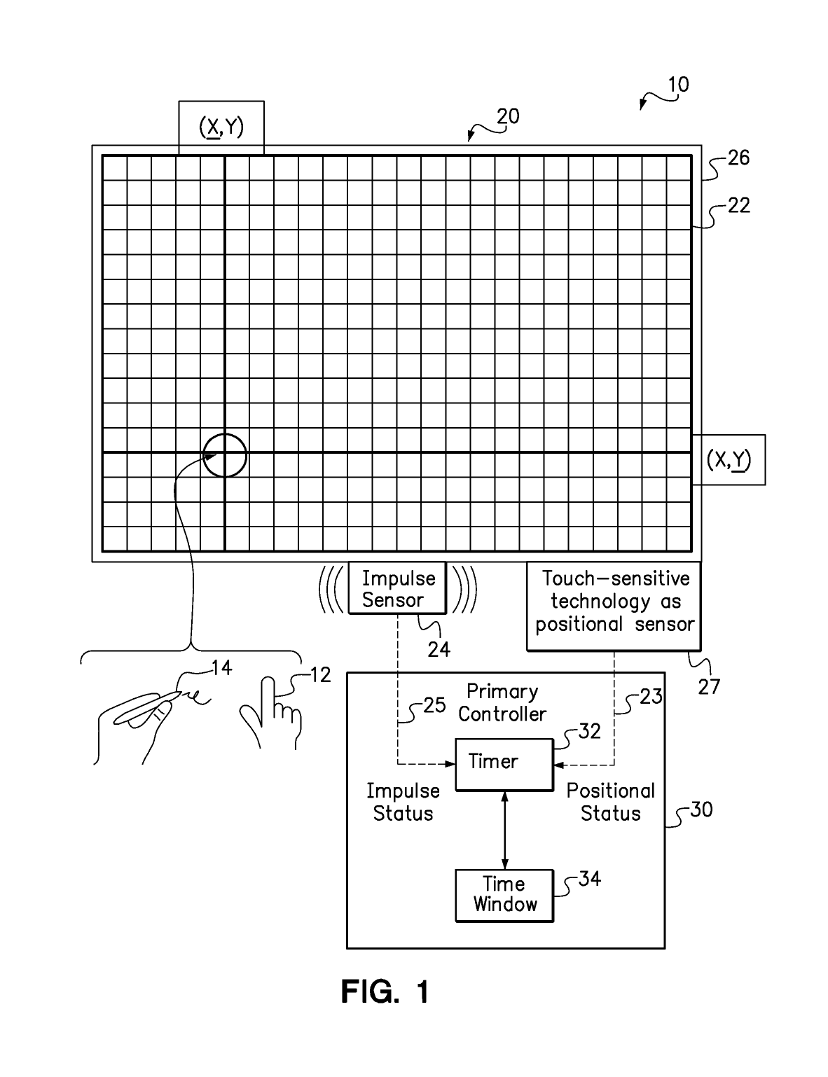

FIG. 1 is a schematic diagram of a touch-sensitive input/output device 10 providing two levels of verification for confirming intended touch input. The device 10 includes a display screen 20 having a touch-sensitive display area 22 and an outer bezel 26. The display screen 20 may generate visual output anywhere in the display area 22 using any of a variety of display technologies known in the art, such as LCD (liquid-crystal display), LED (light-emitting diode), PDP (plasma display panel), or even CRT (cathode ray tube). Touch-sensitive circuitry (not shown) built-in to or otherwise included with the display screen 20 functions as a positional sensor (diagrammatically indicated at 27), to sense the position at which the display area 22 is touched, for example using a user's finger 12 or a handheld implement, such as a stylus 14. The touch-sensitive circuitry may include any of a variety of touch-sensitive display technologies, including but not limited to infrared, resistive, capacitive, or surface acoustic wave touchscreen technologies. The touch-sensitive circuitry is capable of sensing the position at which the display area 22 is touched with a resolution represented in FIG. 1 by an X-Y grid. This positional information is registered at the controller 30. The resolution of the sensed position may be, for example, on the order of one pixel width used in the display screen 20. The position may be represented, for example, using rectangular (X,Y) coordinates. The display screen 20 generates a positional signal 23 representative of the detected position. The positional signal 23 is sent to a primary controller 30 for interpretation. The primary controller 30 may comprise an integrated circuit, such as a processor or application-specific integrated circuit (ASIC) embedded within the display screen 20 or otherwise in electronic communication with the position-specific sensor elements of the display screen 20 for processing and interpreting touch input to the display screen 20.

A second sensor, referred to as the impulse sensor 24, is coupled to the display-screen 20. The impulse sensor 24 may be coupled to the display screen 20 either directly or with an intermediary member (not shown), such that movement of the display screen is propagated to the impulse sensor 24. The impulse sensor 24 is sensitive to movement, such as an impact, caused by a user's finger 12 or stylus 14 coming into contact with the display screen 20. The impulse sensor 24 may be embodied, for example, as a vibration or impact sensor, such as a low-cost piezoelectric sensor rigidly coupled to the display screen 20, or to a common housing such as a cell phone housing. The impulse sensor 24 generates an impulse signal 25 in response to the sensed impulse. The impulse signal 25 may be registered at the primary controller 30. The primary controller 30 may include control logic for determining whether the sensed impulse is consistent with contact with an external object, such as the finger 12 or stylus 14, contacting the display screen 20. For example, the control logic may be used to determine if the amplitude and/or frequency of a movement, vibration or impact is consistent with the display area 22 being touched by the user's finger 12 or a stylus 14. The impulse sensor 24 need not (and typically does not) detect or provide any position-specific information; thus, any activity that results in a sudden movement of the display screen 20 detectable by the impulse sensor 24 will generate the impulse signal 25, regardless of the location of the activity.

A first level of verification involves establishing “concurrency” of the positional signal 23 and the impulse signal 25. Each time one of the signals 23, 25 is generated, that signal is registered by the controller 30 for a period of time referred to as a status hold period. The status hold periods for the impulse sensor 24 and the position sensor 27 may be measured in milliseconds (ms). Concurrency of the detected impulse and positional information is established when the status of the impulse sensor 24 and the status of the positional sensor 27 are both currently registered. The impulse signal 25 thereby corroborates the positional signal 23 as an indication that the touch input was intended. For example, a particle of dust on the display screen 20 that is sufficiently large to trigger the location-specific touch sensing elements of the display screen 20 would likely produce so little impact, vibration or displacement as to be undetectable by the impulse sensor 20. Likewise, the relatively low-frequency vibration or relatively large displacement cause by the palm of a hand or other large object inadvertently contacting the display screen 20 may also be filtered out or ignored by the impulse sensor 24.

A second level of verification involves establishing the “coincidence” of the detected impulse and positional information according to the timing at which the impulse and positional information are registered, to minimize or eliminate false indications of touch input. The impulse sensor 24 and position sensor 27 may occasionally be triggered by separate, unassociated activity, neither of which is intended as touch input to the display screen 20. For example, a first event, such as a dust particle or object hovering near the display screen 20, may trigger the position sensor 27, and a separate event, such as a rigid object striking the outer bezel 26 of the display screen 20, may trigger the impulse sensor 24. These may incidentally occur close in time.

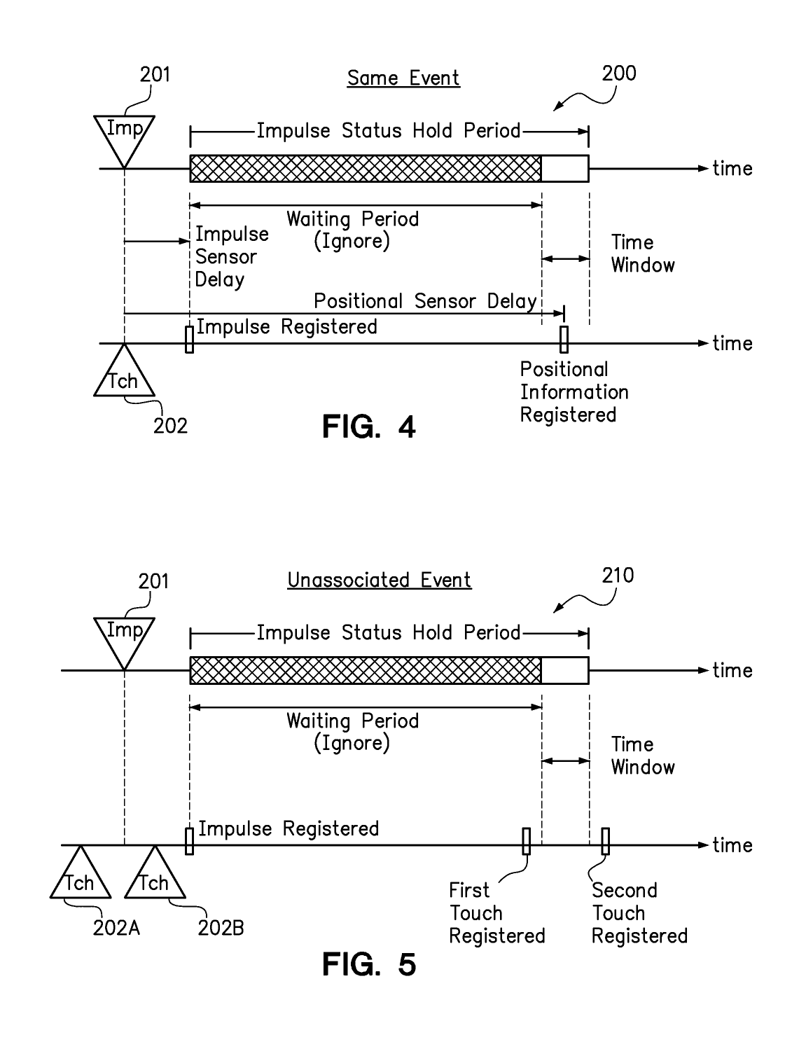

The primary controller 30 includes a timer 32 that is responsive to one or both of the positional signal 23 and the impulse signal 25. The timer 32 may be embodied as an electronic timer circuit and/or control logic included with the primary controller 30. In response to one of the positional signal 23 and impulse signal 25 being generated, the status of the respective sensor 24, 27 is registered by the controller 30. The status is held for a period of time referred to herein as the status hold period. After a predefined waiting period, a timer 30 is initiated to begin timing a predefined time window 34 that spans at least the remainder of the status hold period. If the other of the positional signal 23 and the impulse signal 25 is received at any time during the predefined time window 34 (and not outside of the time window 34), the primary controller 30 verifies the activity as intended touch input. The length of the predefined waiting period and the timing window 34 help in determining whether the registered impulse and positional information arose from the same activity, as further diagrammed and explained in FIGS. 4 and 5.

When an intended touch has been confirmed by both levels of verification described above (i.e. concurrence and coincidence), the positional signal 23 is then interpreted as touch input. The input may be static, such as the pressing of a virtual button displayed in the display area 22 to make an electronic selection or entry. The input may also be dynamic, such as to generate input that changes with changing position of touch (caused, for example, by sliding of the finger 12 or stylus 14 on the display area 22). The positional information provided in the positional signal 23 is processed by an associated application program, operating system or touchscreen driver included with the primary controller 30. The primary controller 30 or software code in communication with the primary controller 30 may dynamically generate visual output on the display screen 20 according to the coordinates or a change in coordinates of the positional signal 23. Positional information may be dynamically generated by motion of the finger 12 or stylus 14 on the display area 22. Visual output may be generated as a function of the dynamically generated input, for as long as the contact with the display area 22 is maintained. Such motion may include, for example, dragging the finger 12 or stylus 14 along the display area 22, so that the associated response may include moving a graphical display object (GROB) along the display area 22. Such motion of the finger 12 or stylus 14 may further include gestures, which include predefined actions taken in response to predefined patterns of touch motion, including multiple touch input signals at various positions. Input may also be generated in response to relatively brief contact with the display area 22 at a single, specific position. Such input may include a tap to select a GROB, or a virtual key press. Removal of the finger 12 or stylus 14 from the display area 22 may be detected, for example, by at least a momentary cessation of the positional signal 23.

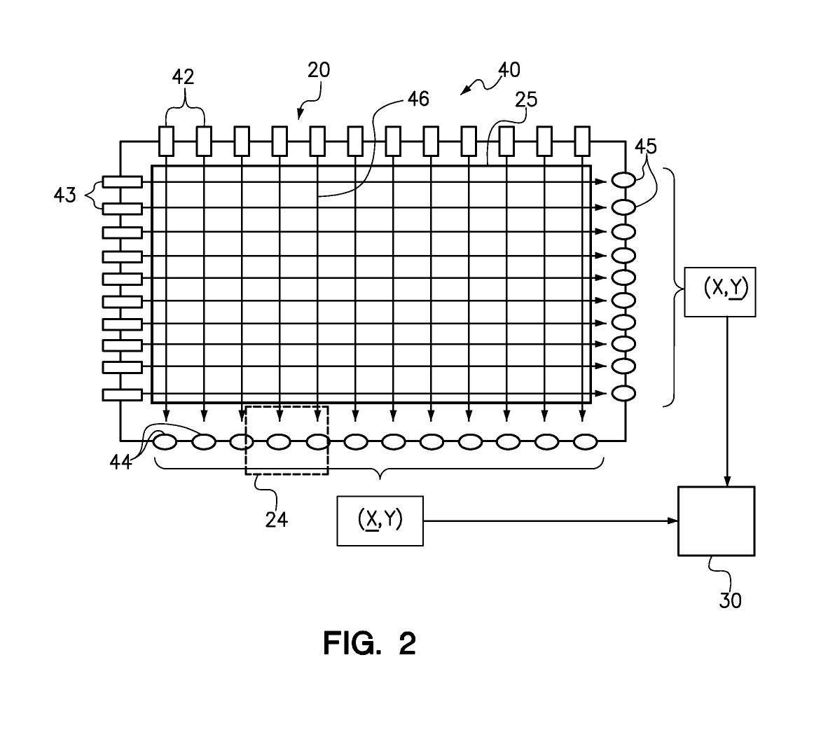

FIG. 2 is a schematic diagram of an IR sensor array 40, provided as an example of touch-sensitive circuitry that may be used with the display screen 20 of FIG. 1. The IR sensor array 40 as depicted in FIG. 2 does not require a bare finger to provide the touch, as in a typical capacitive touchscreen. This feature makes an IR touchscreen desirable for use in an environment in which using a bare finger on a touchscreen may not be practical, such as in certain point of sale (POS) applications or industrial applications where gloves are required, or where a stylus is preferred.

The IR sensor array 40 in this example includes a plurality of IR emitters and IR receivers. For example, the IR sensor array 40 includes a row of IR emitters 42, a column of IR emitter 43, a row of IR receivers 44 and a column of IR receivers 45. Each IR emitter 42 is generally aligned in one-to-one correspondence with an IR receiver 44. Each IR emitter 43 is generally aligned in one-to-one correspondence with an IR receiver 45. IR beams generated by the row of IR emitters 42 and the column of IR emitters 43 intersect to form a grid 46. When unobstructed, the IR beam generated by each IR emitter 42 (in the top row) is received by the corresponding IR receiver 44 (in the bottom row), and the IR beam generated by each IR emitter 43 (in the left column) is received by the corresponding IR receiver 45 (in the right column). When the display area 22 is touched by a finger or stylus, the finger or stylus interferes with the IR beam(s) at that position, thus blocking the corresponding IR receivers 44, 45 from receiving an IR beam. The row of IR receivers 44 and the column of IR receivers 45 report to the primary controller 30 as to which IR receiver(s) are being blocked, from which the primary controller 30 may infer the respective X and Y positional information. If the impulse sensor (see FIG. 1) also reports an impulse signal to the primary controller 30 that is consistent with the display area 22 being touched by a finger, stylus or other object, then intended touch input may be verified according to concurrence and coincidence, as discussed above with reference to FIG. 1.

The grid 46 may actually be spaced a small distance away from the physical outer surface of the display area 22, such that the IR beams can be blocked even when an object gets close to the display screen 20 without actually touching the display screen 20. As a result, positional information can be reported to the primary controller, but no impulse signal will be generated by the finger or stylus because no contact was actually made with the display area 22. Using the second level of verification (timing positional and impulse signals) described with reference to FIG. 1, intended touch input will not be confirmed, and the positional information in such an instance may be ignored.

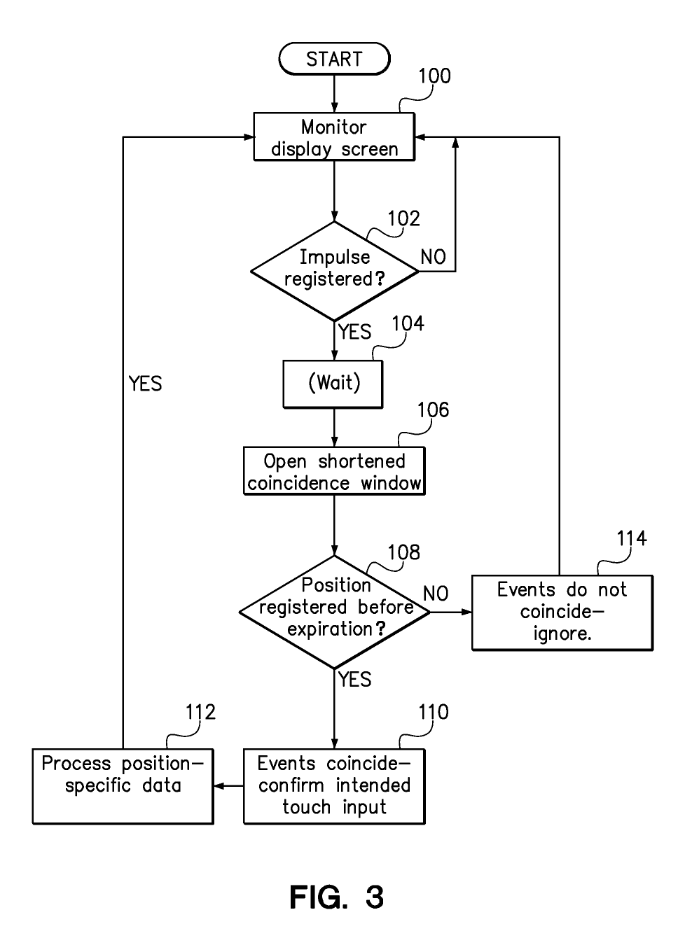

FIG. 3 is a flowchart of an example method of detecting and interpreting touch input to a touch-sensitive display screen, while identifying and excluding activity not intended as touch input. The flowchart describes a system wherein the positional sensor is significantly slower to register positional information than the impulse sensor is to register an impulse. This is consistent with present impulse and positional sensor technology, wherein the response time for an impulse sensor is typically much faster than the response time for positional sensing circuitry used in touch-screen displays. Thus, it may be assumed that the impulse will be registered by the time the positional information is registered if the impulse and positional information arose from the same event.

In step 100, the display screen is monitored for a positional signal and an impulse signal. The positional signal may be dynamically generated by positional sensor circuitry in the display screen in response to a finger or stylus contacting a display area of the display screen. The impulse signal may be dynamically generated by an impulse sensor in response to an impact, vibration, displacement, or other movement of the display screen. The signal generated by the impulse sensor may be monitored to determine if the detected impulse is consistent with being touched by a finger or stylus. For example, vibration frequencies or other movement artifacts may be filtered out as being inconsistent with being touched by a finger or stylus.

Conditional step 102 determines whether the impulse is registered while the display screen is being monitored. Because the impulse sensor is assumed to have a faster response time, the impulse is expected to be registered before the positional information if the impulse and subsequently registered positional information arose from the same event. For that reason, positional information can be ignored in the absence of a registered impulse. In response to the impulse being registered, an impulse status hold period is initiated along with a waiting period in step 104. At the end of the waiting period, the time window for checking for a coincident positional signal (i.e. coincidence window) is initiated. The length of the waiting period is selected based on the difference between the known delay of the positional sensor and the known delay of the impulse sensor. The waiting period may continue until just before the earliest time that associated positional information can be expected to be registered, based on the known positional sensor delay. Thus, any position signal occurring during the waiting period is assumed to be caused by a separate, unassociated event, and can be ignored. The time window is initiated in step 106 at the conclusion of the waiting period. The time window has a significantly shorter duration than the status hold period, and typically terminates at the conclusion of the status hold period. Specifically, the time window may be initiated just prior to the earliest expected time that the positional information is expected to be registered if arising from intended touch input. Likewise, the impulse status hold period and the included time window may extend until just after the latest expected time that the positional information is expected to be registered.

Conditional step 108 determines whether the positional information has been registered before expiration of the predefined time window. If the positional information has been registered before the expiration of the time window (i.e., during the time window), then coincidence is established in step 110, confirming intended touch input. Otherwise, the impulse and touch are assumed to have arisen from separate events, and may be ignored per step 114. If intended touch input is confirmed within the predefined time window per step 110, then the positional information is processed in step 112. For example, positional information may be electronically analyzed by a primary controller to determine whether the touch input was intended to provide a keystroke of a virtual keyboard, a repositioning of a graphical display object (GROB), or a gesture intended to invoke a predefined function associated with that gesture. Visual output may be generated as a function of the positional information. Visual output may be actively, dynamically generated as changing positional information is received, such as to drag a GROB along the display screen to track movement of a finger or stylus that is in sliding contact with the display screen.

FIG. 4 is a timing diagram 200 illustrating the verification of intended touch input as confirmed by coinciding impulse and positional information. An impulse 201 to the display screen and a touch 202 to a touch-sensitive area of the display screen occur simultaneously, as indicated by the connecting dashed line, since they arise from the same event. However, due to sensor delays inherent to the particular sensors, the impulse is registered after an impulse sensor delay, and the positional information is registered after a positional sensor delay. An impulse status hold period is initiated at the moment the impulse is registered. A waiting period is initiated along with the impulse status hold period. The waiting period continues until some time before a lower limit on the positional sensor delay, at which point a time window opens. The time window continues until some time after an upper limit on the positional sensor delay. The upper and lower limits on the positional sensor delay may be empirically determined for the particular positional sensor or type of positional sensor used. The time window is preferably as short as possible while still including the upper and lower limit on the positional sensor delay.

In the example of FIG. 4, the positional information arising from the touch to the touch-sensitive display area is registered at some time during the time window, which falls somewhere between the lower and upper limits on the expected positional sensor delay. Because the positional information is registered during this time window, the impulse 201 and touch 202 are determined to have arisen from the same event, and the positional information obtained from the positional sensor is confirmed as intended touch input. The positional information can then be used to generate electronic input as a function of the positional information, such as the pressing of a button or movement of a GROB.

FIG. 5 is a timing diagram 210 illustrating the timing of signals arising from unassociated events distinguishable from intended touch input. The impulse status hold period and waiting period are the same as in FIG. 4. However, a first touch 202A arising from an unassociated touch event occurs shortly before the impulse 201. A second touch 202B also arising from an unassociated touch event occurs shortly after the impulse 201. The first touch 202A is registered a short time before the time window, and is determined to be unassociated with the impulse. The second touch 202B is registered a short time after the time window, and is also determined to be unassociated with the impulse 201. Since no positional information is registered during the time window, no touch input is verified. The positional information from the two touches 202A, 202B is ignored.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
detecting an impulse to a display screen using an impulse sensor coupled to the display screen;
detecting a touch to a touch-sensitive area of the display screen;
holding a sensor status for a predefined waiting period following the first of the detected impulse and the detected touch;
initiating a time window at the end of the predefined waiting period;
checking for the other of the impulse and the touch to occur during the time window; and
confirming an intended touch input in response to the other of the impulse and the touch having occurred during the time window.

2. The method of claim 1, further comprising:
initiating the time window at the earliest expected time for the other of the impulse and the touch to be registered and concluding the time window at the latest expected time for the other of the impulse and the touch to be registered.

3. The method of claim 1, further comprising:
detecting the position of touch to the touch-sensitive area of the display screen; and
generating a display output as a function of the position of touch.

4. The method of claim 1, further comprising:
detecting a changing position of the touch; and
generating the electronic input as a function of the changing position of the touch.

5. The method of claim 1, further comprising:
detecting a removal of the touch; and
in response to the removal of the touch, generating the electronic input as a function of positional information obtained from when the intended touch input was confirmed until detecting the removal of the touch.

6. The method of claim 1, wherein detecting the impulse comprises:
detecting one or more of a vibration of the display screen and a displacement of the display screen.

7. The method of claim 6, further comprising:
obtaining a predetermined range of one or both of the vibration and the displacement consistent with intended touch input; and
confirming intended touch input if the vibration or displacement are within the predetermined ranges.

8. The method of claim 1, wherein detecting the position of touch to the display screen comprises:
emitting an infrared beam generally parallel to the display screen; and
detecting a disturbance of the infrared beam and the position of that disturbance.

9. The method of claim 1, wherein detecting the position of touch to the display screen comprises:
detecting a capacitive or resistive response at or near the detected position.

10. The method of claim 1, wherein the time window is between 0 and 2 milliseconds.

11. A touch-sensitive input/output device, comprising:
a display screen;
an impulse sensor coupled to the display screen, the impulse sensor configured for detecting an impulse to the display screen and generating an impulse signal in response;
a positional sensor configured for detecting a position of touch to the display screen and generating a positional signal in response; and
a primary controller including control logic for holding a sensor status for a predefined waiting period following the first of the detected impulse and the detected touch, initiating a time window at the end of the predefined waiting period, checking for the other of the impulse and the touch to occur during the time window, and confirming an intended touch input in response to the other of the impulse and the touch having occurred during the time window.

12. The touch-sensitive input/output device of claim 11, further comprising:
control logic included with the primary controller for dynamically generating a positional signal in response to a changing position of the touch to the display screen; and
control logic included with the primary controller for generating electronic input as a function of the changing position of the touch.

13. The touch-sensitive input/output device of claim 11, further comprising:
control logic included with the primary controller for detecting a removal of the touch from the display screen; and
control logic included with the primary controller for, in response to the removal of the touch, generating the electronic input as a function of positional information obtained from when the intended touch input was confirmed until detecting the removal of the touch.

14. The method of claim 13, further comprising:
control logic included with the primary controller for, in response to detecting the removal of the touch, repeating the steps of detecting one of an impulse to a display screen and a position of touch to a display screen, initiating a timer in response to detecting one of the impulse to the display screen and the position of touch to the display screen, monitoring for the other of the impulse and the position of touch before the expiration of a predefined time interval, and, in response to detecting the other of the impulse and the position of touch before the expiration of the predefined time interval, confirming an intended touch input and generating electronic input as a function of the detected position of touch.

15. The touch-sensitive input/output device of claim 11, wherein the impulse sensor is configured to detect the impulse by detecting one or more of a vibration of the display screen and a displacement of the display screen.

16. The touch-sensitive input/output device of claim 15, further comprising:
control logic included with the primary controller for comparing the vibration or displacement to a predetermined range of one or both of the vibration and the displacement consistent with intended touch input; and confirming intended touch input if the vibration or displacement are within the predetermined ranges.

17. The touch-sensitive input/output device of claim 11, wherein the positional sensor comprises:
a plurality of infrared emitters each configured for emitting an infrared beam generally parallel to the display screen;
a plurality of infrared receivers configured for receiving the infrared beams; and
control logic included with the primary controller for inferring the position of the touch according to which of the infrared beams are blocked by the touch.

18. The touch-sensitive input/output device of claim 11, wherein the positional sensor comprises:
one of a capacitive and resistive sensor configured for detecting a change in capacitance or resistance in response to the touch.
